(19) United States
(12) Patent Application Publication
(10) Pub. No.: US 2020/0307743 A1
(43) Pub. Date: Oct. 1, 2020

(54) CLOSING DEVICE

(71) Applicants: THYSSENKRUPP MARINE SYSTEMS GMBH, Kiel (DE); thyssenkrupp AG, Essen (DE)

(72) Inventors: Hans OESMANN, Hamburg (DE); Marko SCHULZ, Drage (DE); Sebastian HALFMANN, Norderstedt (DE)

(73) Assignees: THYSSENKRUPP MARINE SYSTEMS GMBH, Kiel (DE); thyssenkrupp AG, Essen (DE)

(21) Appl. No.: 16/300,616

(22) PCT Filed: Jun. 14, 2017
(86) PCT No.: PCT/EP2017/064475

§ 371 Date: Nov. 12, 2018

(30) Foreign Application Priority Data
Jun. 14, 2016 (DE) 10 2016 210 531.0

(51) Int. Cl. B63B 19/19; B63B 19/08

(52) U.S. Cl. CPC B63B 19/19; E05Y 2900/514; B63B 19/08

(57) ABSTRACT

A closing device configured to close an outer shell opening of a surface ship, including several substantially vertically mounted shutter lamellas and a drive device by means of which the shutter lamellas can be actuated such that they move between a closed position and an open position.

The invention relates to a closing device for closing an outer shell opening of a surface ship, comprising several substantially vertically mounted shutter lamellas and a drive device by means of which the shutter lamellas can be actuated such that they move between a closed position and an open position.

Such closing devices are normally used in military surface ships in order to close spaces arranged inside the outer shell of the ship, and open these towards the outside when necessary. These spaces normally serve as stowage compartments for dinghies which can be launched onto the water from the compartments when the closing device is opened, for which purpose for example a lifting device may be provided.

The closing device must withstand the same loads from water pressure and shock as the outer shell of the ship, and must therefore be designed correspondingly to the outer shell with regard to strength.

JP 2004 026 091 A describes a cover for a helicopter hangar of a marine vessel, wherein the cover is formed from vertical shutter lamellas and is designed for a small signature. Furthermore, DE 102 56 984 B4 describes a cover device for a recess in an outer shell of a ship, wherein the recess is part of a launcher for firing mortars and/or rocket-like munitions. This cover device is also designed for a good signature. DE 10 2004 035 640 A1 discloses a closure for an access opening to a cabin of a yacht with horizontally arranged shutter lamellas. This known prior art however pays no attention to the structural design of the closure or cover with regard to the effect of wave impacts or shock.

On this basis, the object of the present invention is to improve a closing device with regard to resistance to the effects of wave impact or shock.

The object is achieved by a closing device for closing an outer shell opening of a surface ship, comprising several substantially vertically mounted shutter lamellas and a drive device by means of which the shutter lamellas can be actuated such that they move between a closed position and an open position, and wherein the shutter lamellas in an upper and a lower end region are held relative to each other via sliding elements in an upper and a lower guide rail of the closing device, such that on movement from the closed position to the open position, the shutter lamellas fold alternately against each other to assume the open position.

According to the invention, it is now provided that the forces occurring as a result of wave impact or shock are conducted via the sliding elements into the upper and lower guide rails and from there into the ship's structure. Therefore there is no need for the shutter lamellas to be guided in the guide rails via rollers.

An advantageous embodiment of the invention provides that an even number of shutter lamellas is provided, which can be moved in equal parts to opposite sides of the outer shell opening into the open position. In this way, firstly the conditions are created for a simple structure of the drive device, since the loading can be applied symmetrically to both parts of the shutter lamellas. Secondly, in this way, the shutter lamellas can be stowed evenly distributed on both sides of the outer shell opening in the open position.

An advantageous embodiment of the invention provides that mutually facing end sides of the sliding elements of adjacent shutter lamellas stand in an active relationship to each other via a pressure-transmission region, such that a longitudinal force imposed on the shutter lamellas in the movement direction for assuming the open position generates a transverse force component on the pressure-transmission region. In this way, advantageously it is achieved that the kinematics introduced for folding the shutter elements when moving into the open position are controlled solely by the design of the sliding elements, in particular their end faces, and no additional moving and/or actuated components need be provided. In particular, it may be provided that the pressure-transmission region of the end faces of the sliding elements is formed as a rounded contour so that adjacent sliding elements can roll on each other when assuming the open position. This guarantees a low-friction relative movement between the sliding elements. Furthermore, the shape of the contour with regard to curvature may serve to deliberately influence or change the behavior of the shutter lamellas on folding.

An advantageous embodiment of the invention provides that the sliding elements of adjacent shutter lamellas are connected together via respective connecting members. In this way, in particular a force transmission between the shutter lamellas on moving from the open position to the closed position is guaranteed. Furthermore, the connecting members perform a guidance function between the shutter lamellas on moving from the closed position to the open position.

An advantageous embodiment of the invention provides that the drive device actuates at least one of the shutter lamellas to move between the closed position and the open position, and indirectly actuates the other shutter lamellas via the at least one shutter lamella. This arrangement guarantees that the shutter lamellas which are connected only indirectly to the drive device can fold up into the open position independently of the drive device.

An advantageous embodiment of the invention provides that the drive device comprises at least one roller chain via which the at least one shutter lamella is actuated to move between the closed position and the open position. A roller chain is a robust drive means which is simple to handle.

An advantageous embodiment of the invention provides that the upper and lower guide rails comprise slide surfaces made of plastic for guiding the sliding elements in a lateral direction and a vertical direction. The plastic slide surfaces allow both low-friction sliding of the shutter lamellas and transmission of the loads from wave impact and in the event of shock to the ship's structure.

An advantageous embodiment of the invention provides that the shutter lamellas are made from a CRP, GRP, steel or aluminum material. In this way, the shutter lamellas are able to withstand the water pressure.

An advantageous embodiment of the invention provides that the guide rails have an inner and an outer side guide stop in the movement direction of the shutter lamellas relative to the outer shell opening. This guarantees guidance of the shutter lamellas in the guide rails on both sides.

An advantageous embodiment of the invention provides that the inner side guide stop extends with a shorter path in the direction of the closed position of the shutter lamellas than the outer side guide stop. This guarantees that at least some of the shutter lamellas can be released from the guide rails in the direction of the inside of the ship so that they can be brought into the folded open position.

An advantageous embodiment of the invention provides that the guide rails each have a guide groove running in the movement direction. The guide groove guarantees that the shutter lamellas continue to be guided by the guide rails although they are in a movement position in which they have already been released from the guide rails in the direction of the inside of the ship.

An advantageous embodiment of the invention provides that the sliding elements have a guide bolt via which the sliding elements are held in the guide grooves for guidance in the movement direction. The guide bolts guarantee that the shutter lamellas can pivot in controlled fashion relative to the guide rails as soon as the shutter lamellas are in a movement position in which they have already been released from the guide rails in the direction of the inside of the ship.

An advantageous embodiment of the invention provides that the guide bolt is arranged in the region of one of the end faces of the sliding element, wherein adjacent sliding elements are arranged relative to each other such that the end faces, in the region of which the guide bolts are arranged, or the corresponding opposite end faces, in the region of which no guide bolts are arranged, lie opposite each other. This guarantees that two mutually opposing end faces of the sliding elements are alternately guided or not guided in the guide groove. This achieves the alternating folding of the shutter lamellas against each other while reaching the open position, since the shutter lamellas can pivot away in the direction of the inside of the ship in the region in which the end faces of the sliding elements are not guided in the guide grooves by means of guide bolts, as soon the sliding elements have been released from the guide rails in the direction of the inside of the ship.

An advantageous embodiment of the invention provides a contact pressure device by means of which the two outer shutter lamellas in a closed position can be pressed against an outer stop towards the outside of the ship.

The invention is now described below with further features, details and advantages with reference to the attached figures. The figures illustrate merely exemplary embodiments of the invention. The drawings show:

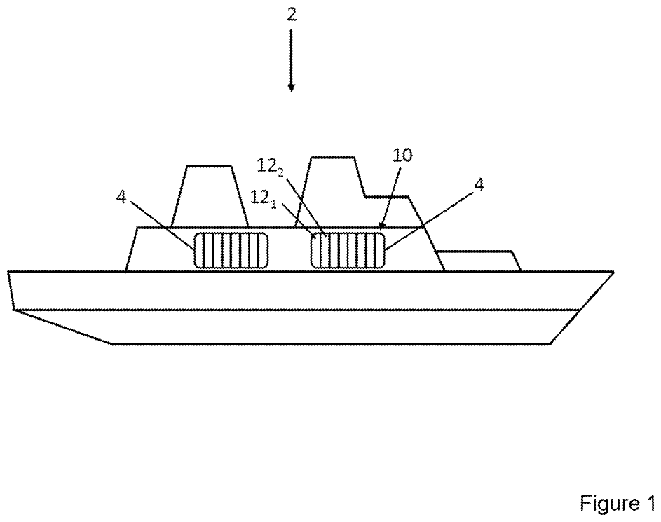

FIG. 1 a surface ship with two outer shell openings and closing devices covering these;

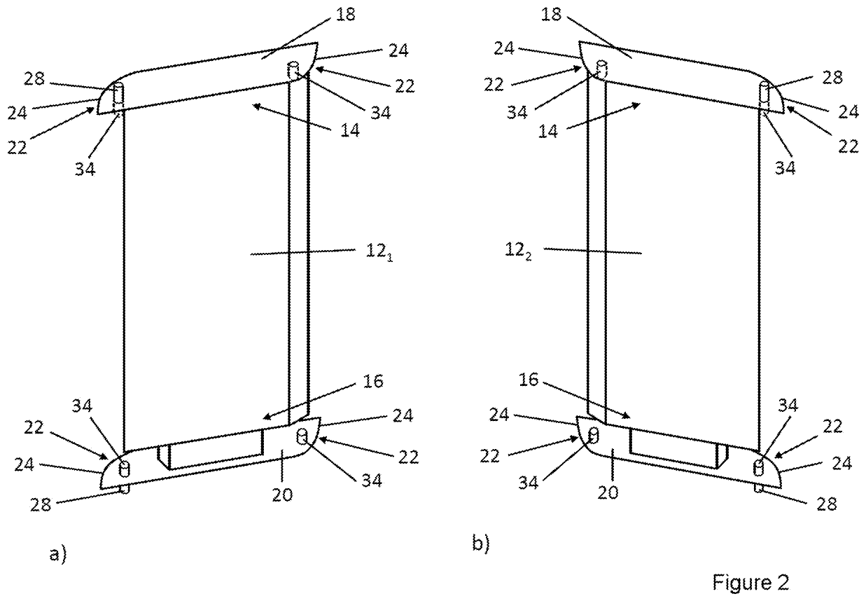

FIGS. 2a, 2b two embodiments of a shutter lamella;

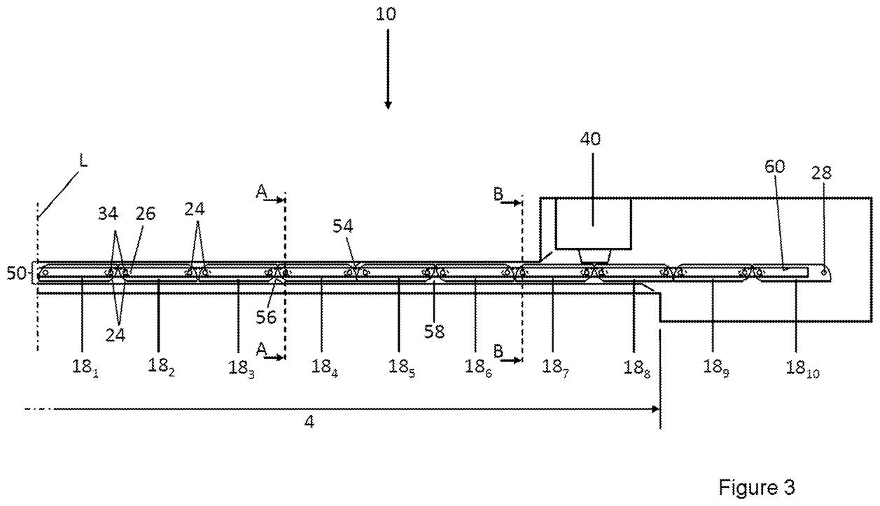

FIG. 3 a top view of a closing device;

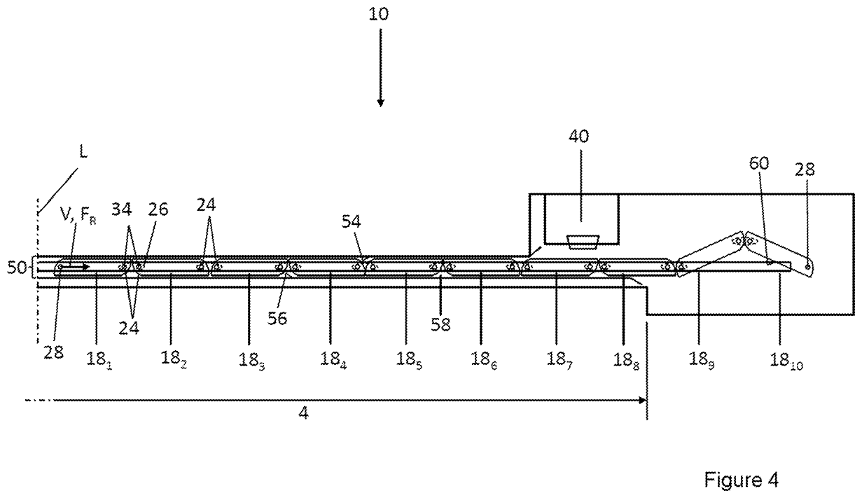

FIG. 4 a further top view of a closing device;

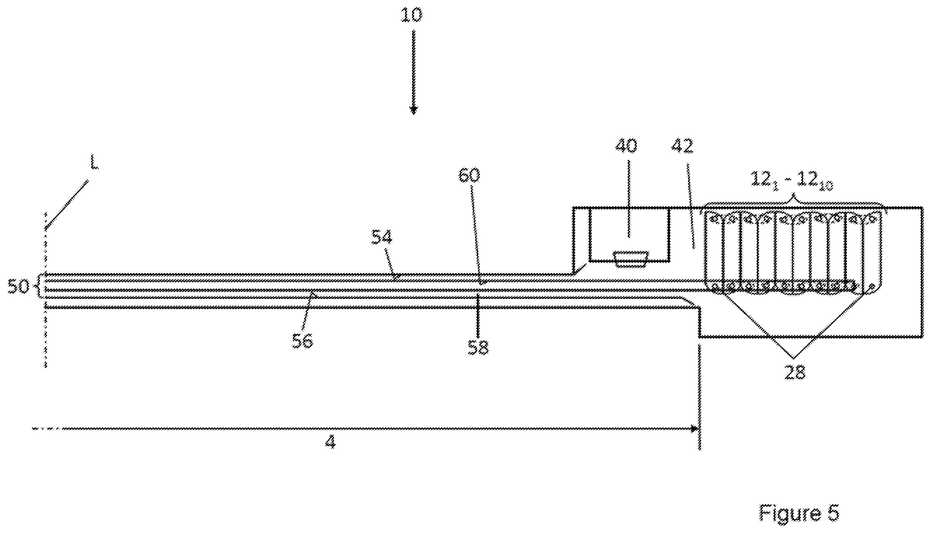

FIG. 5 a further top view of a closing device;

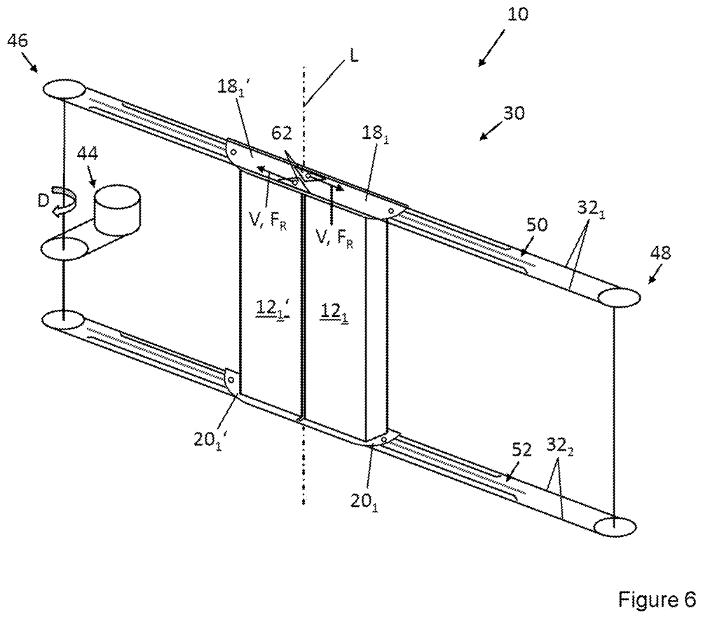

FIG. 6 a perspective view of a closing device;

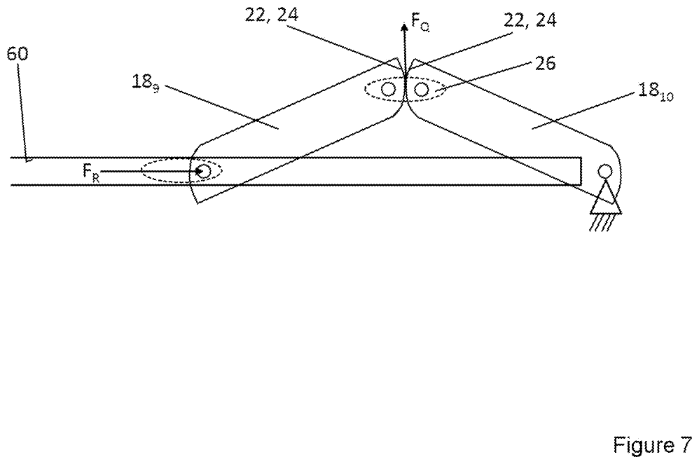

FIG. 7 a detail view of two sliding elements of a closing device, and

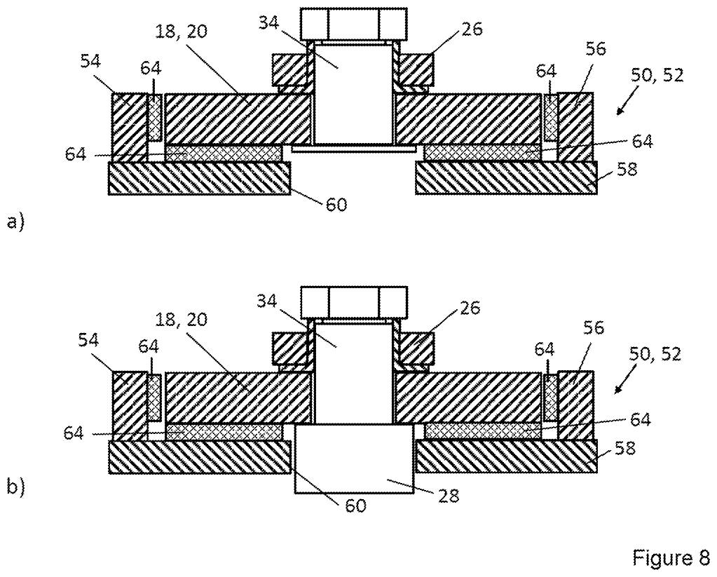

FIGS. 8a, 8b two detail views of a sliding element guided in a guide rail of the closing device.

FIG. 1 shows a surface ship 2 in the form of a marine ship. Above a water surface (not designated further), the surface ship 2 has two outer shell openings 4, the number of which in the present case should be regarded as exemplary. The outer shell openings 4 are each covered by a closing device 10, wherein the closing device 10 can be moved between a closed position (shown here) and an open position. For this, the closing device 10 has several movable shutter lamellas 12 which are oriented substantially vertically. In the present case, purely as an example, a closing device 10 is fitted with eight shutter lamellas 12, wherein any number deviating from this may be provided. However, it is preferred that the number of shutter lamellas 12 is even. Furthermore, it is preferred that the shutter lamellas 12 can be moved in equal parts to opposite sides of the outer shell opening 4 into the open position, i.e. starting from the closed position, they open the outer shell opening 4 centrally and move into the open position at the sides of the outer shell opening 4.

FIG. 2a) shows in perspective view a possible embodiment of a shutter lamella 12₁. FIG. 2b) shows a shutter lamella 12₂ designed symmetrically thereto. The shutter lamellas 12₁, 12₂ are described jointly below. The shutter lamella 12 has a sliding element 18 and 20 in each of an upper end region 14 and a lower end region 16. The terms “upper” and “lower” in the present description refer to the normally prevailing position of the surface ship, in which this lies horizontally on a water surface. At their end faces 22, the sliding elements 18, 12 have pressure-transmission regions 24, via which adjacent shutter lamellas 12 can come into active connection, as will be described below. Furthermore, the sliding elements 18, 20 each have a guide bolt 28 oriented upward or downward respectively towards one side, and a connecting bolt 34 oriented inward towards the other side, the function of which will also be described below.

FIG. 3 shows a top view of the closing device 10 according to the invention, of which however, for reasons of clarity, only one half is shown and in which the second half adjoining the dotted line L has been omitted. The top view is selected such that the upper sliding elements 18 lie in the drawing plane. Furthermore, the interior of the ship is in the upper image half, and the exterior of the ship accordingly in the lower image half. Also, only half of the outer shell opening 4 is shown. The line L is not necessarily a line of symmetry, since it is preferably provided that a drive device is arranged in the region of one of the halves of the closing device 10, as will be explained below. The closing device 10 is shown in the closed position. Initially, ten sliding elements 18₁ are 18₁₀ are shown, so the corresponding shutter lamellas 12 are oriented into the drawing plane. The sliding elements 18₁ to 18₁₀ are arranged in pairs relative to each other with regard to their pressure-transmission regions 24, such that they run symmetrically to each other relative to a center line between the sliding elements 18. The arrangement means that over the course of the sliding elements 18, adjacent pressure-transmission regions 24 have a contour which opens alternately towards the outside of the ship and towards the inside of the ship.

Adjacent sliding elements 18 are connected together by means of connecting members 26 over the connecting bolts 34. Here each connecting member 26 is pivotable about a vertical axis relative to the respective connecting bolt 34. Thus adjacent sliding elements 18 are connected together via the connecting members 26 in the manner of chain links. The connecting members 26 are arranged on the inside of the sliding elements 18 relative to the shutter lamellas 12.

Furthermore, the closing device 10 comprises guide rails 50 and 52, of which FIG. 3 shows only the upper guide rail 50. The upper guide rail 50 and the lower guide rail 52 (shown in FIG. 6) are designed correspondingly to each other. The closing device 10 or the shutter lamellas 12 of the closing device 10 can be guided via the guide rails 50, 52 from the closed position to the open position and vice versa. The guide rail 50 is configured substantially U-shaped in cross-section, as shown in FIGS. 8a) and 8b). The guide rail 50 comprises an inner guide stop 54, an outer guide stop 56 and a middle guide stop 58, by means of which the sliding elements 18 are guided in the lateral and vertical directions. Furthermore, the middle guide stop 58 has a guide groove 60 in which the guide bolts 28 of the sliding elements 18, 20 engage in order to be guided. For reasons of clarity, the guide bolts 28 are not shown in FIG. 3, so reference is made to FIGS. 2a) and 2b). The sliding elements 18, 20 of the first shutter lamella 12₁ accordingly have on the left side guide bolts 28 protruding into the guide groove 60, whereas the right side of the sliding elements 18, 20 of the first shutter lamella 12₁ has no guide bolts and is not guided by the guide groove 60. The second shutter lamella 12₂ and its sliding elements 18, 20 are designed symmetrically to the first shutter lamella 12₁, i.e. the sliding elements 18, 20 of the second shutter lamella 12₂ have no guide bolts on the left side and are not guided by the guide groove 60, while the right side of the sliding elements 18, 20 has guide bolts 28 protruding into the guide groove 60. These differences are shown more clearly in the detail views of FIGS. 8a) and 8b). This alternating arrangement of the shutter lamellas 12, their sliding elements 18, 20 and the guide bolts 28 on the sliding elements 18, 20, continues in the further shutter lamellas 12₃ to 12₁₀, wherein however the guide bolt 28 of the shutter lamella 12₁₀ is no longer guided inside the guide groove 60 but held merely rotatably in the guide rail 50 so as to form a fixed rotation point for the shutter lamella 12₁₀.

Viewed from the line L, the inner guide stop 54 of the guide rail 50 has a shorter length than the outer guide stop 56 of the guide rail 50. In the region of this length difference, a contact pressure device 40 is arranged in the inside of the ship, by means of which the two shutter lamellas 18₇ and 18₈ can be pressed against the outer guide stop 56 towards the outside of the ship in the closed position.

FIG. 4 shows the closing device 10 in a position in which the shutter lamellas 12 have been moved by a certain amount from the closed position in the direction of the open position. The contact pressure device 40 is here in a retracted position in which it is clear of the shutter lamellas 12₇ and 12₈. The movement direction V is indicated with an arrow which has its contact point in the guide bolt 28 of the sliding element 18₁ of the first shutter lamella 12₁. Furthermore, this arrow symbolizes also a longitudinal force F_{V} acting in the movement direction V, which is applied by the drive device 30 (to be described) on the sliding elements 18, 20 of the first shutter lamella 12₁ in order to move the shutter lamellas 12 from the closed position to the open position. In particular, according to the invention it is provided that this longitudinal force is applied directly onto the sliding elements 18, 20 of the first shutter lamella 12₁ and from there transmitted successively and indirectly to the following shutter lamellas 12₂ to 12₁₀.

FIG. 5 shows the closing device 10 or the shutter lamellas 12₁ to 12₁₀ in the fully open position. In the open position, the shutter lamellas 12₁ to 12₁₀ are folded alternately against each other in order to be arranged compactly in a stowage area 42. Folded alternately against each other means that in pairs, firstly the outward-facing surfaces of the shutter lamellas 12 are oriented against each other, and secondly the inward-facing surfaces of the shutter lamellas 12 are oriented against each other. Also, with reference to the depiction in FIG. 5, it should be stated that only one half the closing device 10 is shown, as symbolized by the line L and already described above.

FIG. 6 shows the closing device 10 in a diagrammatic depiction and not to scale. It shows the drive device 30, the upper and lower guide rails 50, 52, and two shutter lamellas 12₁ and 12₁′. The two shutter lamellas 12₁, 12₁′ are the respective first shutter lamella 12 of the two halves of the closing device 10 as described above. The two shutter lamellas 12₁, 12₁′ can be moved by the drive device 30 to opposite sides into the open position. The drive device 30 comprises an upper roller chain 32₁ and a lower roller chain 32₂, drive means 44, for example in the form of an electric motor or a pneumatic motor for driving the roller chains 32₁, 32₂, and two deflectors 46, 48 on opposite sides of the closing device 10 and over which the roller chains 32₁, 32₂ are guided. The deflector 46 is driven by the drive means 44 and the other deflector 48 is designed to be passive. The two roller chains 32₁, 32₂ are driven via the deflector 46. The two roller chains 32₁, 32₂ are configured as endless chains and each connected for drive purposes to the two shutter lamellas 12₁ and 12₁′. Here, the upper roller chain 32₁ is connected to the upper sliding elements 18₁ and 18₁′, and the lower roller chain 32₂ is connected to the lower sliding elements 20₁ and 20₁′ of the shutter lamellas 12₁, 12₁′. The outer strands, relative to the inside and outside of the ship respectively, of the two roller chains 32₁, 32₂ are here connected to one of the shutter lamellas 12₁, 12₁′, in the present case the shutter lamella 12₁′, and the inner strands of the two roller chains 42, 44 are here connected to the other of the shutter lamellas 12₁′, 12₁, in the present case the shutter lamella 12₁. The roller chains 42, 44 are connected to the sliding elements 18, 20 via carrier elements 62, of which only those of the upper sliding element 18₁′, 18₁ are shown. The carrier elements 62, viewed in the movement direction V, are arranged with an undercut to each other so that the two shutter lamellas 12₁, 12₁′ are braced relative to each other in the closed position.

In order to move the shutter lamellas 12 from the closed position shown to the open position, the drive means 44 may be driven in the rotation direction D symbolized by the arrow. In this way, in the movement direction V, a longitudinal force F_{V} is exerted on the roller chains 32₁, 32₂ so that the respective front strand of both roller chains 32₁, 32₂ moves the shutter lamella 12₁′ to the left, while the respective rear strand of both roller chains 32₁, 32₂, due to the 180° looping around the deflector 48, moves the shutter lamella 12₁ to the right. When the drive means 44 is rotated in the opposite direction, the shutter lamellas 12 are moved accordingly into the closed position. As already described, the shutter lamellas 12 are here guided via the sliding elements 18, 20 in the upper and lower guide rails 50, 52.

FIG. 7 shows in a detailed depiction the process of folding the two sliding elements 18₉ and 18₁₀ against each other, as has already been shown for the half of the closing device depicted in FIG. 4. The sliding element 18₁₀ is held pivotably but immovably at one end, for example on the guide rail 50 or directly on the ship's structure. The sliding element 18₉ is held at one end movably in the guide groove 60, and at this end is subjected to a longitudinal force F_{R} as has been described in connection with FIG. 6. The mutually facing ends of the sliding elements 18₉, 18₁₀ are in contact via curved pressure-transmission regions 24, and hence in an active connection. At these ends, the sliding elements 18₉, 18₁₀ are not guided in the guide groove 60 but merely connected pivotably together via the connecting member 26. Due to the curved or rounded pressure-transmission regions 24 on the end faces 22 of the sliding elements 18₉, 18₁₀, an automatic folding of the shutter lamellas 12 occurs on assuming the open position. This folding movement is controlled by a transverse force component F_{Q} of the longitudinal force F_{R} which acts in the contact point of the pressure-transmission regions 24₁, 24₂ of the two sliding elements 18₁, 18₂.

FIGS. 8a) and 8b) show cross-sections along the section lines A-A and B-B shown in FIG. 3. FIG. 8a) shows a connecting bolt 34 held by corresponding fixing means in the sliding element 18, 20, and via which the connecting member 26 is pivotably arranged on the sliding element 18, 20. FIG. 8b) shows, as well as the connecting bolt 34, a guide bolt 28 via which the sliding element 18, 20 is guided in the guide groove 60 of the guide rail 50, 52. In both FIGS. 8a) and 8b), it is evident that slide surfaces 64 are arranged on both the middle guide stop 58 and on the inner and outer guide stops 54, 56. These slide surfaces 64 are preferably made of plastic and thus allow a particularly low-friction sliding of the sliding elements 18, 20 in the guide rails 50, 52 on movement of the closing device 10 between the closed position and the open position.

### LIST OF REFERENCE SIGNS

2 Surface ship
4 Outer shell opening
40 Closing device
12 Shutter lamella
14 End region
16 End region
18 Sliding element
20 Sliding element
22 End face
24 Pressure-transmission region
26 Connecting member
28 Guide bolt
30 Drive device
32 Roller chain
34 Connecting bolt
40 Contact pressure device
42 Stowage area
44 Drive means
46 Deflector
48 Deflector
50 Guide rail
52 Guide rail
54 Guide stop
56 Guide stop
58 Guide stop
60 Guide groove
62 Carrier element
64 Slide surface
V Movement direction
F_{R} Longitudinal force
F_{Q} Transverse force

1.-10. (canceled)

11. A closing device for closing an outer shell opening of a surface ship, comprising:
several substantially vertically mounted shutter lamellas,
a drive device by means of which the shutter lamellas can be actuated between a closed position and an open position, and
sliding elements configured to hold the shutter lamellas in an upper and a lower end region relative to each other in an upper and a lower guide rail of the closing device, such that on movement from the closed position to the open position, the shutter lamellas fold alternately against each other to assume the open position.

12. The closing device of claim 11, wherein the shutter lamellas are provided in an even number, which are movable in equal parts to opposite sides of the outer shell opening into the open position.

13. The closing device of claim 11, wherein mutually facing end sides of the sliding elements of adjacent shutter lamellas stand in an active relationship to each other via a pressure-transmission region such that a longitudinal force imposed on the shutter lamellas in the movement direction for assuming the open position generates a transverse force component on the pressure-transmission region.

14. The closing device of claim 13, wherein the pressure-transmission region of the end faces of the sliding elements is formed as a rounded contour so that adjacent sliding elements are configured to roll on each other when assuming the open position.

15. The closing device of claim 11, wherein the sliding elements of adjacent shutter lamellas are connected together via respective connecting members.

16. The closing device of claim 11, wherein the drive device actuates at least one of the shutter lamellas to move between the closed position and the open position, and indirectly actuates the other shutter lamellas via the at least one shutter lamella.

17. The closing device of claim 16, wherein the drive device comprises at least one roller chain via which the at least one shutter lamella is actuated to move between the closed position and the open position.

18. The closing device of claim 11, wherein the upper and lower guide rails comprise slide surfaces made of plastic for guiding the sliding elements in a lateral direction and a vertical direction.

19. The closing device of claim 11, wherein the shutter lamellas are made from a CRP, GRP, steel or aluminum material.

20. The closing device of claim 11, wherein the guide rails have an inner and an outer side guide stop in the movement direction of the shutter lamellas relative to the outer shell opening.
